(19) United States
(12) Patent Application Publication
(10) Pub. No.: US 2011/0102695 A1
(43) Pub. Date: May 5, 2011

(54) LIQUID CRYSTAL DISPLAY DEVICE DRIVING METHOD AND LIQUID CRYSTAL DISPLAY DEVICE

(76) Inventors: Takashi Katayama, Osaka (JP); Masahiro Shimizu, Osaka (JP)

(21) Appl. No.: 12/673,439

(22) PCT Filed: Aug. 12, 2008
(86) PCT No.: PCT/JP2008/064478

§ 371 Date: Feb. 12, 2010

(30) Foreign Application Priority Data
Sep. 7, 2007 (JP) 2007-233423

(51) Int. Cl. G02F 1/136

(52) U.S. Cl. 349/41

(57) ABSTRACT

The present invention is characterized in that: switching elements are transistor elements (36); a plurality of gate bus lines (32) and a plurality of source bus lines are provided on an active matrix substrate (10) in a lattice manner; each of the transistor elements (36) is connected to at least one of the gate bus lines (32) and at least one of the source bus lines; and a period is secured during which no electric potential difference occurs between any adjacent ones of the plurality of pixel electrodes (17) between which a corresponding one of the plurality of gate bus lines (32) is provided, at least while a transition voltage for causing a transition of the liquid crystal molecules into the bend orientation state is being applied to the liquid crystal layer, by simultaneously putting all of the plurality of gate bus lines (32) into an ON state so that voltages of identical polarity are applied to the respective any adjacent ones of the plurality of pixel electrodes (17).

### TECHNICAL FIELD

The present invention relates to a method of driving a liquid crystal display device, and a liquid crystal display device. The present invention particularly relates to an OCB (Optically Self-Compensated Birefringence) mode liquid crystal display panel and an OCB mode liquid crystal display device.

### BACKGROUND ART

A liquid crystal display device has the advantages that it (i) is thinner and lighter than a CRT (Cathode Ray Tube) display device and (ii) consumes less electric power than the CRT (Cathode Ray Tube) display device because the liquid crystal display device can be driven by a lower voltage than the CRT (Cathode Ray Tube) display device. Therefore, the liquid crystal display device has been used in a variety of electronic devices such as a television set, a laptop computer (personal computer), a desktop personal computer, a PDA (personal digital assistant, i.e., a mobile terminal), and a mobile phone.

Meanwhile, an electronic device, such as a liquid crystal television, which displays a moving image on a liquid crystal display panel, has been rapidly widespread. In view of the circumstances, it has been necessary that the liquid crystal display panel have a high-speed response so as to achieve a good moving image. On this account, it is an OCB panel with high-speed response that has particularly attracted attention recently.

(Structure of OCB Panel)

An OCB mode liquid crystal display panel is arranged such that: liquid crystal molecules are provided between two substrates which have been subjected to an alignment treatment so as to cause the liquid crystal molecules to be aligned in a same direction in parallel with one another; wave plates are provided on surfaces of the respective two substrates; and polarization plates are provided on the respective wave plates so that the polarization plates are in a crossed Nicols relation. Here, a negative wave plate whose major axis is hybrid-aligned is used as the wave plate, for example.

A structure of the OCB panel and an orientation of liquid crystal molecules are specifically described with reference to FIGS. 7 and 8. FIGS. 7 and 8 are cross-sectional views each schematically illustrating a structure of an OCB mode liquid crystal display device 1. FIG. 7 illustrates an orientation state of liquid crystal molecules 52 while no voltage is applied. FIG. 8 illustrates an orientation state of the liquid crystal molecules 52 while a voltage is being applied.

As illustrated in FIGS. 7 and 8, a liquid crystal display panel 5 of the liquid crystal display device 1 includes (i) a first substrate 10 serving as a TFT substrate (an active matrix substrate) that includes TFT (Thin Film Transistor) elements and is constituted by a first glass substrate 11 on which a wiring layer 13, an insulating layer 15, pixel electrodes 17, and a first alignment film 19 are provided and (ii) a second substrate 20 serving as a counter substrate that is constituted by a second glass substrate 21 on which a color filter 23, a counter electrode 27, and a second alignment film 29 are provided. A liquid crystal layer 50 containing the liquid crystal molecules 52 is sandwiched between the first substrate 10 and the second substrate 20.

More specifically, the first alignment film 19 and the second alignment film 29 have been subjected to an alignment treatment by rubbing (a rubbing alignment treatment).

The liquid crystal display device 1 includes TFTs so as to carry out active matrix driving with respect to the liquid crystal layer 50. The TFTs are provided for respective pixels, and each of the TFTs is connected to a corresponding one of gate bus lines and a corresponding one of source bus lines. The gate bus lines and the source bus lines, which are not illustrated, are provided on the first glass substrate.

The first glass substrate 11 and the second glass substrate 21 are combined via spherical spacers or columnar spacers (not illustrated).

Furthermore, a wave plate (not illustrated) and a polarization plate (not illustrated) are attached to a surface of each of the first substrate 10 and the second substrate 20, which surface is opposite to a surface facing the liquid crystal layer 50, so as to at least improve a viewing angle characteristic of a display.

(Orientation of Liquid Crystal Molecules)

According to the OCB mode liquid crystal display device 1, the liquid crystal molecules 52 are in a spray orientation state while no voltage is applied (see FIG. 7). While a voltage is being applied, a transition (a spray-bend transition) of the liquid crystal molecules 52 into a bend orientation state occurs as illustrated in FIG. 8 (this is called a spray-bend transition). A display is carried out by changing a tilting angle of each of the liquid crystal molecules 52 during the bend orientation state.

More specifically, as illustrated in FIG. 7, the liquid crystal molecules 52 that have just been injected are in the spray orientation state (initial orientation state), in which each of the liquid crystal molecules 52 is in substantially parallel with the first substrate 10. The transition of the liquid crystal molecules 52 that are in the spray orientation state into the bend orientation state generally occurs in response to a voltage applied to the liquid crystal molecules 52. Specifically, while a relatively high voltage, e.g., 25 V, is being applied to the liquid crystal molecules 52 that are in the spray orientation state, a transition occurs from a spray orientation into a bend orientation state, and then the liquid crystal molecules 52 in a display surface are sequentially changed into the bend orientation state (see FIG. 8).

As described earlier, the OCB mode liquid crystal display device 1 carries out an actual display while the liquid crystal molecules 52 are being in the bend orientation state. Therefore, the spray-bend transition must be carried out every time the liquid crystal display device 1 is powered on.

Generally, the spray-bend transition is not easily carried out, as described in for example Patent Literature 1. In order to carry out the spray-bend transition, it is necessary, for example, to keep applying such a relatively high voltage to the liquid crystal layer for a predetermined period or longer.

In order to carry out the spray-bend transition in a short period of time, for example, Patent Literature 1 discloses a technique in which (i) a reset period during which the liquid crystal layer is changed into a uniform spray orientation state is secured after a power-on operation (after the liquid crystal display device is powered on), and then (ii) a transition period is secured during which a high voltage is applied to the liquid crystal layer so as to cause a transition of the liquid crystal layer into the bend orientation state.

### CITATION LIST

### Patent Literature 1

Japanese Patent Application Publication, Tokukai, No. 2003-121881 A (Publication Date: Apr. 23, 2003)

### SUMMARY OF INVENTION

However, the conventional structure has not taken into consideration a spray-bend transition that spreads beyond a bus line such as a gate bus line. Accordingly, the bend orientation hardly spreads into an adjacent pixel via the bus line. This causes a problem that the time required for the spray-bend transition was not sufficiently shortened. This is described below in more detail.

(Transition into Bend Orientation)

As described earlier, the OCB mode liquid crystal display device achieves a high-speed response and a wide viewing angle characteristic, by (i) causing a transition of the liquid crystal molecules from the spray orientation state into the bend orientation state (i.e., by causing the spray-bend transition) at a time when the liquid crystal display device is started up by a power-on operation, and then (ii) driving the liquid crystal display device while the liquid crystal molecules are being in the bend orientation state.

The spray-bend transition in the OCB mode can be broadly separated into the following two steps.

(First Step)

A first step is directed to how a bend orientation (a bend transition core) is generated.

In order to cause a transition of the liquid crystal molecules from the spray orientation into the bend orientation in a short period of time, a bend transition core, which is a starting point from which the bend orientation spreads, is generally generated. Each of pixels of the liquid crystal display panel includes a core-generating part for generating the bend transition core.

In the first step of the spray-bend transition, either (i) the core-generating part generates a bend transition core or (ii) a first bend orientation region (origin of the bend orientation) appears in a case where no core-generating part is provided.

(Second Step)

Next, in a second step, the bend orientation is propagated all over a liquid crystal display panel in the bend orientation state so as to start at the bend transition core or at the origin of the bend orientation.

More specifically, in a case where the core-generating part is included in each of the pixels, a bend transition core is first generated in each of the pixels. Next, the bend orientation occurs at the bend transition core, and spreads within each of the pixels. Then, the bend orientation further spreads all over the liquid crystal display panel. The second step is thus carried out.

(Problem)

In the conventional liquid crystal display device, there has been a problem that it takes a long time for the bend orientation to spread all over the liquid crystal display panel. This is described below with reference to FIG. 9. FIG. 9 is a cross-sectional view of the liquid crystal display device 1, schematically illustrating an orientation state of the liquid crystal molecules 52 provided between adjacent pixel electrodes 17 (a pixel electrode 17a and a pixel electrode 17b).

Generally, the spray-bend transition is carried out by applying to the liquid crystal molecules 52 a voltage higher than a voltage to be applied during the normal driving. For example in a case of sequentially driving the gate bus lines and the source bus lines with the use of TFTs, if an inversion driving, such as a line inversion driving or a dot inversion driving, is carried out while such a high voltage is being applied, then an electric potential difference occurs between the adjacent pixel electrodes 17a and 17b between which a corresponding gate bus line 32 is provided. The electric potential difference thus occurred causes a lateral electrical field (see the dashed arrow of FIG. 9) to be generated.

In other words, in a case of carrying out an inversion driving such as the line inversion driving with respect to a TFT, the gate bus lines 32 are sequentially in an ON state. Accordingly, electric potentials having respective different polarities are written to respective adjacent ones of pixels 30. That is, different electric potentials are written to the respective adjacent pixel electrodes 17a and 17b between which the corresponding gate bus line 32 is provided. As such, an electric potential difference occurs between the pixel electrodes 17a and 17b, thereby causing the lateral electrical field to be generated.

More specifically, in a case of an example illustrated in FIG. 9, a counter electrode 27 has an electric potential of Vcom, and the pixel electrodes 17a and 17b respectively have electric potentials V1 and V2 that are different from each other. In a case where the electric potential V1 is larger than the electric potential V2, an electrical field is generated so as to point from the pixel electrode 17b toward the pixel electrode 17a (see the direction indicated by the solid arrow of FIG. 9).

In a case where the liquid crystal molecules 52 to be used have positive dielectric anisotropy (p-type liquid crystal), the liquid crystal molecules 52 in a region (a region R2 shown in FIG. 9) between the adjacent pixel electrodes 17a and 17b are oriented along an electric flux line indicated by the dashed line arrow illustrated in FIG. 9, i.e., in a direction substantially parallel with the first substrate 10. Namely, it is in the horizontal direction that the liquid crystal molecules 52 in the region R2 are stably oriented by the lateral electrical field generated between the adjacent pixel electrodes 17a and 17b. It should be noted that the liquid crystal molecules 52 having positive dielectric anisotropy intend to liquid crystal molecules 52 having a characteristic in which they are oriented so that their longitudinal direction is in parallel with the electrical field while a voltage is being applied to the liquid crystal molecules 52.

Meanwhile, in order for the bend orientation to spread all over the liquid crystal display panel 5 in a short period of time, it is preferable that the bend orientation spread from a corresponding one of the pixels 30 into its adjacent one of the pixels 30 beyond a corresponding one of the gate bus lines 32.

According to the example illustrated in FIG. 9, the bend orientation spreads from (i) a region (a region R1 shown in FIG. 9) above the pixel electrode 17a in which region the liquid crystal molecules 52 are already in the bend orientation state, into (ii) a region (a region R3 shown in FIG. 9) above the pixel electrode 17b that is adjacent to the pixel electrode 17a (that is, the bend orientation spreads in a direction indicated by the thick arrow of FIG. 9). This allows the spreading of the spray-bend transition all over the liquid crystal display panel 5 to complete in a shorter period of time.

However, according to the conventional liquid crystal display device 1, the bend orientation needs to pass through the region R2 while it is spreading from the region R1 into the region R3. The region R2 is a region in which the liquid crystal molecules 52 are stably oriented in the horizontal direction.

That is, in a case where, during a transition from (i) the spray orientation that is nearly a horizontal orientation to (ii) the bend orientation that is nearly a vertical orientation, the bend orientation spreads from the region R1 (the region above the pixel electrode 17a) to the region R3 (the region above the pixel electrode 17b which is adjacent to the pixel electrode 17a), the bend orientation needs to spread, via the region R2 (the region between the pixel electrodes 17a and 17b) in which there is force that will cause a transition from the bend orientation into the spray orientation. This causes the bend orientation in the region R1 to hardly spread into the region R3 (the region above the pixel electrode 17b that is adjacent to the pixel electrode 17a), via a corresponding one of the gate bus lines 32). As such, there has been a problem that the bend orientation hardly spreads all over the liquid crystal display panel 5 at least due to the fact that it takes a long period of time for the bend orientation to spread all over the liquid crystal display panel 5.

The present invention has been made in view of the problems, and an object of the present invention is to achieve, in a liquid crystal display device including a plurality of pixel electrodes, a method of driving a liquid crystal display device and a liquid crystal display device each capable of carrying out a spray-bend transition all over a display surface in a short period of time.

In order to attain the object, the method of driving an OCB mode liquid crystal display device in accordance with the present invention, said OCB mode liquid crystal display device including: an active matrix substrate on which a plurality of pixel electrodes and a plurality of switching elements connected to the respective plurality of pixel electrodes are provided in a lattice manner; a counter substrate on which a counter electrode is provided; and a liquid crystal layer sandwiched between the active matrix substrate and the counter substrate, the liquid crystal layer containing liquid crystal molecules that have positive dielectric anisotropy, the liquid crystal molecules being in a spray orientation state while no voltage is applied to the liquid crystal layer, and a transition of the liquid crystal molecules occurring from the spray orientation state into a bend orientation state in response to a voltage applied to the liquid crystal layer, the switching elements being transistor elements, a plurality of gate bus lines and a plurality of source bus lines being provided on the active matrix substrate in a lattice manner, each of the transistor elements being connected to at least one of the plurality of gate bus lines and to at least one of the plurality of source bus lines, said method includes the step of: securing a period during which no electric potential difference occurs between any adjacent ones of the plurality of pixel electrodes between which a corresponding one of the plurality of gate bus lines is provided, at least while a transition voltage for causing a transition of the liquid crystal molecules into the bend orientation state is being applied to the liquid crystal layer, by simultaneously putting all of the plurality of gate bus lines into an ON state so that voltages of identical polarity are applied to the respective any adjacent ones of the plurality of pixel electrodes.

According to the arrangement, a period during which substantially no electric potential difference occurs between any adjacent ones of the plurality of pixel electrodes is secured while a transition voltage for causing a transition of the liquid crystal molecules into the bend orientation state is being applied to the liquid crystal layer.

Under a state where no electric potential difference occurs between any adjacent ones of the pixel electrodes, no lateral electrical field is generated between any adjacent ones of the pixel electrodes. Accordingly, the bend orientation occurred in a corresponding one of pixels easily spreads into its adjacent one of the pixels.

That is, no lateral electrical field is generated in a region between any adjacent ones of the pixel electrodes. Therefore, the liquid crystal molecules having positive dielectric anisotropy are not stably oriented in a horizontal direction. In other words, the region between any adjacent ones of the pixel electrodes rarely disturbs the spreading of the bend orientation, which is nearly the vertical orientation.

Accordingly, the bend orientation easily spreads from the corresponding one of the pixels into its adjacent one of the pixels. Therefore, it is possible to cause the spray-bend transition all over the display surface in a short period of time.

As such, the method of driving the liquid crystal display device in accordance with the present invention makes it possible to cause, in a liquid crystal display device including a plurality of pixel electrodes, the spray-bend transition all over a display surface in a short period of time.

Further, according to the arrangement, all the gate bus lines that are each connected to the corresponding ones of switching elements are simultaneously put into the ON state, in a liquid crystal display device in which transistor elements such as TFT (Thin Film Transistor) elements are provided as switching elements. Accordingly, ones of the plurality of pixel electrodes which are each connected to the corresponding one of the switching elements and which are connected to an identical one of the source bus lines receive an identical signal voltage from the identical one of the source bus lines.

As such, it is possible to easily eliminate the electric potential difference between any adjacent ones of the pixel electrodes between which a corresponding one of the gate bus lines is provided.

As described above, according to the above-described driving method, the bend orientation started in a corresponding one of the pixels easily spreads into its adjacent one of the pixels. As such, it is possible to easily cause the spray-bend transition all over the display surface in a short period of time.

Further, the method of driving the liquid crystal display device in accordance with the present invention is preferably arranged such that the all of the plurality of the gate bus lines, that were simultaneously put into the ON state, continue to be put into the ON state for a given period of time after the liquid crystal molecules start responding.

According to the arrangement, a voltage drop, which is likely to occur during application of the transition voltage in case of a line sequential driving, becomes unlikely to occur. Accordingly, it is possible to prevent a delay in the transition into the bend orientation. This is described below.

In a case of a so-called line sequential driving, after one of the plurality of gate bus lines is selected and the pixel electrodes are electrically charged, the electric charge thus charged is retained until next time the one of the plurality of the gate bus lines is selected. During this interval, the pixel electrodes are not again electrically charged.

In a case where a transition voltage to be applied to cause the spray-bend transition is applied to the pixel electrodes retaining the electric charge, a dielectric constant ∈ is larger in the bend orientation state than in the spray orientation state. Therefore, a capacitance of the liquid crystal layer increases as a bend orientation region occupies a larger region in a corresponding one of the pixels.

Further, a voltage applied to the liquid crystal layer decreases as the capacitance of the liquid crystal layer increases, because a capacitance is inversely proportional to a voltage. The decrease in the voltage applied to the liquid crystal layer will lead to a delay in the spray-bend transition.

In contrast, according to the above-described arrangement, all of the plurality of gate bus lines are simultaneously put into the ON state so that the liquid crystal molecules respond, and then the plurality of gate bus lines are kept in the ON state for a given period of time.

Accordingly, even in a case where the bend orientation widely spreads and occupies a larger region, it is still possible to achieve a state where the plurality of pixel electrodes are always electrically charged. Therefore, the voltage drop described above is not likely to occur.

As such, it is possible to prevent the delay in the transition into the bend orientation.

The method of driving the liquid crystal display device in accordance with the present invention may be arranged such that the given period of time is a period of time required for completion of the transition of the liquid crystal molecules from the spray orientation state into the bend orientation state.

According to the arrangement, it is possible to more surely prevent the delay in the transition into the bend orientation.

The method of driving, the liquid crystal display device in accordance with the present invention is preferably arranged such that a timing at which the all of the plurality of gate bus lines start to be put into the ON state comes on or before a period during which the transition voltage is being applied.

According to the arrangement, the plurality of gate bus lines are put into the ON state before the transition voltage starts being applied. Therefore, the electric potential difference between any adjacent ones of the plurality of pixel electrodes has already been eliminated at a time when the transition of the liquid crystal molecules starts from the spray orientation state into the bend orientation state.

As such, it is possible to cause the spray-bend transition all over the display surface in a shorter period of time.

The method of driving the liquid crystal display device in accordance with the present invention is preferably arranged such that an identical signal voltage is applied to the transistor elements connected to the respective plurality of gate bus lines all of which are put into the ON state so that the any adjacent ones of the pixel electrodes between which the corresponding one of the plurality of gate bus lines is provided have an identical electric potential.

According to the arrangement, a signal voltage to be applied to each of the plurality of source bus lines is controlled so that in a case of the line sequential driving, no ones of the plurality of pixel electrodes between which the corresponding one of the plurality of gate bus lines is provided.

Such a signal voltage is for example a signal voltage having an identical polarity, particularly a direct-current signal having a constant voltage or a signal voltage causing a white display on an entire surface. Writing such a signal voltage to the any adjacent ones of the plurality of pixel electrodes between which the corresponding one of the gate bus line is provided via a corresponding one of the plurality of source bus lines makes it possible to easily eliminate the electric potential difference between the any adjacent ones of the plurality of pixel electrodes, in the line sequential driving that is the same as a driving carried out for a normal display.

Since no electric potential difference occurs, the lateral electrical field is not generated between the any adjacent ones of the plurality of pixel electrodes.

Accordingly, the bend orientation that occurred in the corresponding one of the pixels easily spreads into its adjacent one of the pixels. As such, it is possible to easily cause the spray-bend transition all over the display surface in a short period of time.

The method of driving an OCB mode liquid crystal display device in accordance with the present invention, said OCB mode liquid crystal display device including: a main active matrix substrate on which a plurality of pixel electrodes and a plurality of switching elements that are connected to the respective plurality of pixel electrodes are provided in a lattice manner; a counter substrate on which a counter electrode is provided; and a liquid crystal layer sandwiched between the main active matrix substrate and the counter substrate, the main active matrix substrate including storage capacitor electrodes, the liquid crystal layer receiving a voltage which varies depending on an electric potential of the counter electrode and an electric potential of the storage capacitor electrodes, the liquid crystal molecules contained in the liquid crystal layer being in a spray orientation state while no voltage is applied to the liquid crystal layer, and a transition of the liquid crystal molecules occurring from the spray orientation state into a bend orientation state in response to a voltage applied to the liquid crystal layer, said method includes the step of: securing a period during which an amplitude of a voltage waveform to be applied to the storage capacitor electrodes is zero at least while a transition voltage for causing a transition of the liquid crystal molecules into the bend orientation state is being applied to the liquid crystal layer.

According to the arrangement, the storage capacitor electrodes are provided on the main active matrix substrate. Further, in applying the transition voltage to the liquid crystal layer, the period is secured during which the amplitude of the voltage waveform to be applied to the storage capacitor electrodes is zero.

The voltage waveform, whose amplitude is zero and which is to be applied to the storage capacitor electrodes, makes it possible to reduce the electric potential difference between the any adjacent ones of the plurality of pixel electrodes. Accordingly, it is possible to easily eliminate or reduce the electric potential difference between the any adjacent ones of the plurality of pixel electrodes by just changing the voltage waveform to be applied to the storage capacitor electrodes. The electric potential difference thus eliminated or thus reduced will lead to a state where no lateral electrical field is generated between the any adjacent ones of the plurality of pixel electrodes, or even if the lateral electrical field is generated, its strength is reduced.

As such, according to the above-described driving method, the bend orientation occurred in the corresponding one of the plurality of the pixels easily spreads into its adjacent one of the pixels. Accordingly, it is possible to easily cause the spray-bend transition all over the display surface in a short period of time.

In should be noted here that the term “main active matrix substrate” is used so as to clearly distinguish the main active matrix substrate from the storage capacitor electrodes. The main active matrix substrate has the same structure as the active matrix substrate except that the storage capacitor electrodes are provided on the main active matrix substrate.

The method of driving the liquid crystal display device in accordance with the present invention is preferably arranged such that a timing at which the voltage waveform whose amplitude is zero starts being applied to the storage capacitor electrodes is a timing that comes on or before a period during which the transition voltage is being applied.

According to the arrangement, the voltage waveform whose amplitude is zero starts being applied to the storage capacitor electrodes before the transition voltage starts being applied. Therefore, the electric potential difference between the any adjacent ones of the plurality of pixel electrodes has already been eliminated or reduced at a time when the transition of the liquid crystal molecules occurs from the spray orientation state into the bend orientation state.

As such, it is possible to cause the spray-bend transition all over the display surface in a short period of time.

A liquid crystal display device of the present invention is preferably driven by the above-described method.

According to the arrangement, it is possible to achieve a liquid crystal display device that is capable of causing the spray-bend transition in a short period of time, because the liquid crystal display device is driven by the above-described method of driving the liquid crystal display device.

The method of driving the liquid crystal display device in accordance with the present invention is characterized by: the switching elements being transistor elements, a plurality of gate bus lines and a plurality of source bus lines being provided on the active matrix substrate in a lattice manner, each of the transistor elements being connected to at least one of the plurality of gate bus lines and to at least one of the plurality of source bus lines, said method including the step of: securing a period during which no electric potential difference occurs between any adjacent ones of the plurality of pixel electrodes between which a corresponding one of the plurality of gate bus lines is provided, at least while a transition voltage for causing a transition of the liquid crystal molecules into the bend orientation state is being applied to the liquid crystal layer, by simultaneously putting all of the plurality of gate bus lines into an ON state so that voltages of identical polarity are applied to the respective any adjacent ones of the plurality of pixel electrodes.

As such, it is possible to provide a method of driving a liquid crystal display device that makes it possible to cause the spray-bend transition all over the display surface in a short period of time, in a liquid crystal display device including a plurality of pixel electrodes.

### BRIEF DESCRIPTION OF DRAWINGS

FIG. 1, showing an embodiment of the present invention, is a block diagram schematically illustrating how a liquid crystal display device is arranged.

FIG. 2 is an explanatory diagram showing a voltage applied to a liquid crystal display panel of the present embodiment.

FIG. 3, showing an embodiment of the present invention, is a cross-sectional view schematically illustrating how liquid crystal molecules orient while a voltage is being applied.

FIG. 4, showing an embodiment of the present invention, is a cross-sectional view schematically illustrating how bend orientation spreads.

FIG. 5 is a circuit diagram illustrating an equivalent circuit of a pixel.

FIG. 6 is a diagram showing a voltage to be applied to the liquid crystal display panel of the present embodiment.

FIG. 7 is a cross-sectional view schematically illustrating an OCB mode liquid crystal display device.

FIG. 8 is another cross-sectional view schematically illustrating the OCB mode liquid crystal display device.

FIG. 9, showing a conventional technique, is a cross-sectional view of a liquid crystal display device, schematically illustrating how liquid crystal molecules are oriented while a voltage is being applied.

### EXPLANATION OF REFERENTIAL NUMERALS

1 Liquid Crystal Display
5 Liquid Crystal Panel
10 First Substrate (Active Matrix Substrate)
11 First Glass Substrate
13 Wiring Layer
15 Insulating Layer
17 Pixel Electrode
19 First Alignment Film
20 Second Substrate (Counter Substrate)
21 Second Glass Substrate
23 Color Filter
27 Counter Substrate
29 Second Alignment Film
30 Pixel
32 Gate Bus Line
34 Source Bus Line
36 TFT (Switching Element)
50 Liquid Crystal Layer
52 Liquid Crystal Molecule
60 Display Control Circuit
62 Gate Driver
64 Source Driver
66 Gray Scale Voltage Generator
68 Power Supply for Driving Counter Electrode

### DESCRIPTION OF EMBODIMENTS

### Embodiment 1

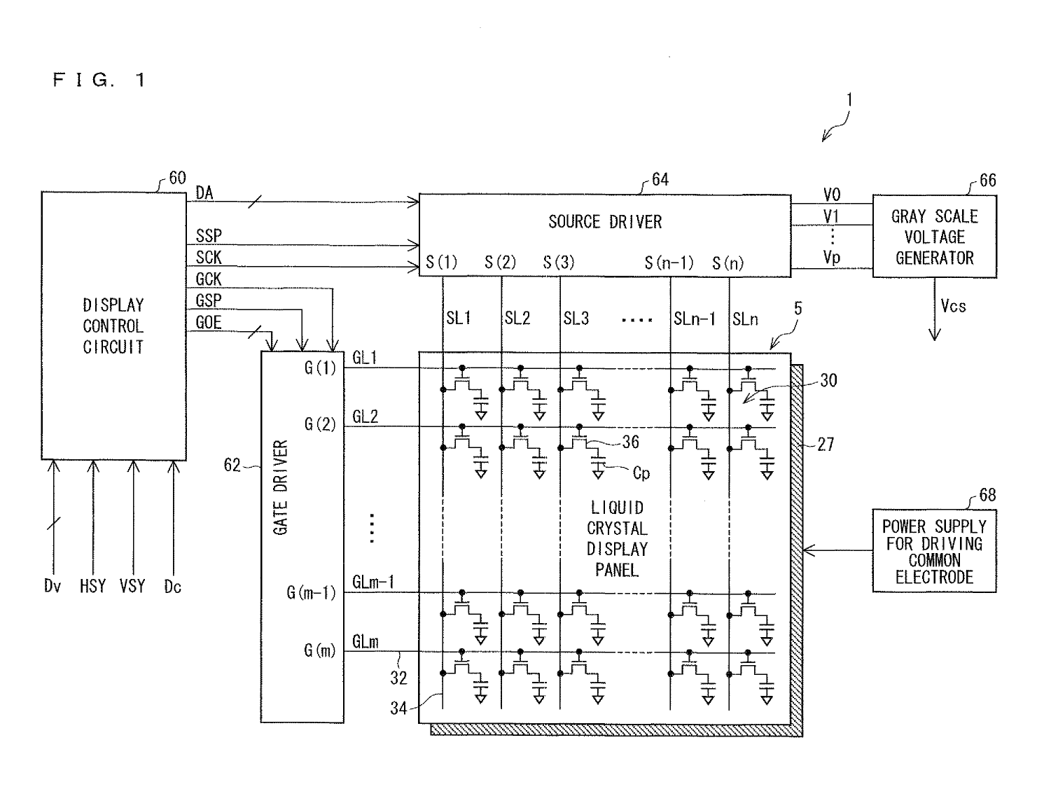

A first embodiment of the present invention is described with reference to FIGS. 1 through 3. FIG. 1 is a block diagram schematically illustrating how a liquid crystal display device 1 is arranged.

The liquid crystal display device 1 of the present embodiment includes: a gate driver 62 serving as a scanning signal line driving circuit; a source driver 64 serving as a data signal line driving circuit; a display control circuit 60 which controls the gate driver 62 and the source driver 64; a gray scale voltage generator 66; a power supply for driving counter electrode 68 for driving a counter electrode 27; and an active matrix type (TFT type) liquid crystal display panel 5.

The liquid crystal display panel 5 in the liquid crystal display device 1 includes: gate bus lines 32 (GL1 through GLm) serving as a plurality of scanning signal lines (m scanning signal lines); source bus lines 34 (SL1 through SLn) serving as a plurality of data signal lines (n data signal lines) which intersect with the gate bus lines 32 (GL1 through GLm); and a plurality of pixels 30 (m×n pixels) which are provided so as to correspond to respective intersections of the gate bus lines 32 (GL1 through GLm) and the source bus lines 34 (SL1 through SLn).

The plurality of pixels 30 are arranged in a matrix manner so as to constitute a pixel array. Each of the plurality of pixels 30 includes: a TFT 36 serving as a switching element; a pixel electrode 17 that is connected to a drain terminal of the TFT 36; a capacitor electrode (not illustrated) that is shared by the plurality of pixels 30; and a liquid crystal layer 50 that is provided for each of the plurality of pixels 30 and that is provided between the respective pixel electrodes 17 and the counter electrode 27 so that the liquid crystal layer 50 is shared by the plurality of pixels 30.

The TFT 36, serving as the switching element, includes: a gate terminal connected to a gate bus line 32 that passes through a corresponding one of intersections; and a source terminal connected to a source bus line 34 that passes through the corresponding one of the intersections.

Moreover, a pixel capacitance Cp is made up of (i) a liquid crystal capacitance defined by a pixel electrode 17 and the common electrode 27 and (ii) a storage capacitance defined by the pixel electrode 17 and a capacitor electrode (storage capacitor line).

The storage capacitor is provided in parallel with the liquid crystal capacitance so that the pixel capacitance surely retains a voltage. Note however that the storage capacitor is not necessarily provided, and therefore may be omitted.

(Brief Summary of Driving)

Next, the following describes how the liquid crystal display device 1 is driven.

The pixel electrode 17 in a corresponding one of the plurality of pixels 30 is given, by the gate driver 62 and the source driver 64, an electric potential which varies depending on an image to be displayed. This causes a voltage, which varies depending on an electric potential difference between the pixel electrode 17 and the common electrode 27, to be applied to a liquid crystal layer 50 (liquid crystal molecules 52). In response to such a voltage, light transmittance of the liquid crystal layer 50 is controlled. In this way, the image is displayed.

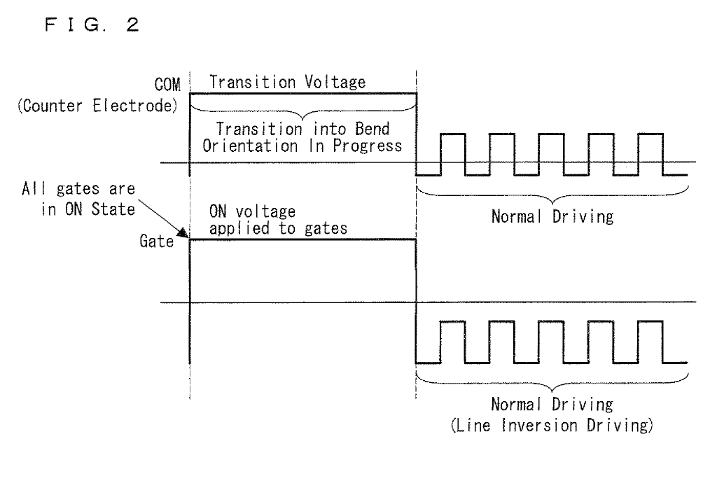

More specifically, as shown in FIG. 2, during a normal driving in which an image or the like is displayed on the liquid crystal panel 5, the gate driver 62 sequentially selects the gate bus lines GL1 through GLm for substantially one horizontal scanning period per gate bus line in each of frame periods (each of vertical scanning periods), and then the source driver 64 writes the data signals S(1) through S(n) into the pixels 30 corresponding to the gate bus line thus selected (this is called a line-sequential driving). During this, for example, the common electrode receives a rectangular wave corresponding to the selection made by a corresponding gate bus line. This causes an inversion driving such as a line inversion driving to be carried out. FIG. 2 is an explanatory diagram showing a voltage (a transition voltage to be applied to the counter electrode (COM electrode), and a gate voltage) applied to a liquid crystal display panel 5 of the present embodiment.

Note in FIG. 1 that DA denotes a digital image signal, SSP denotes a source start pulse signal, SCK denotes a source clock signal, GCK denotes a gate clock signal, GSP denotes a gate start pulse signal, GOE denotes a gate driver output control signal, Dv denotes a digital video signal, HSY denotes a horizontal synchronization signal, VSY denotes a vertical synchronization signal, Dc denotes a control signal, and Vcs denotes a voltage applied to a capacitor electrode.

(Structure of Liquid Crystal Display Panel)

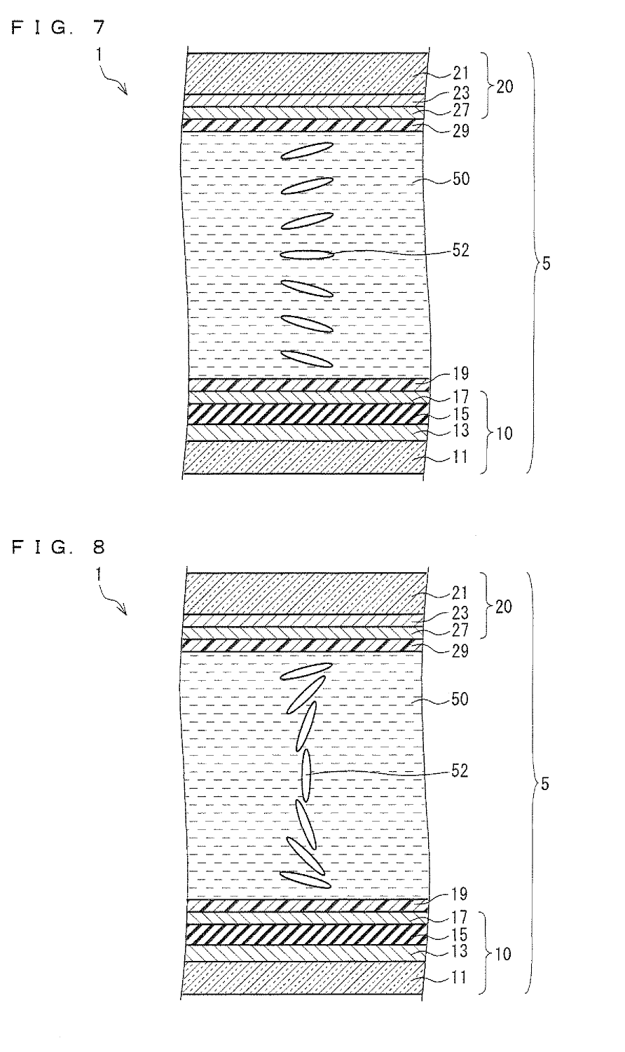

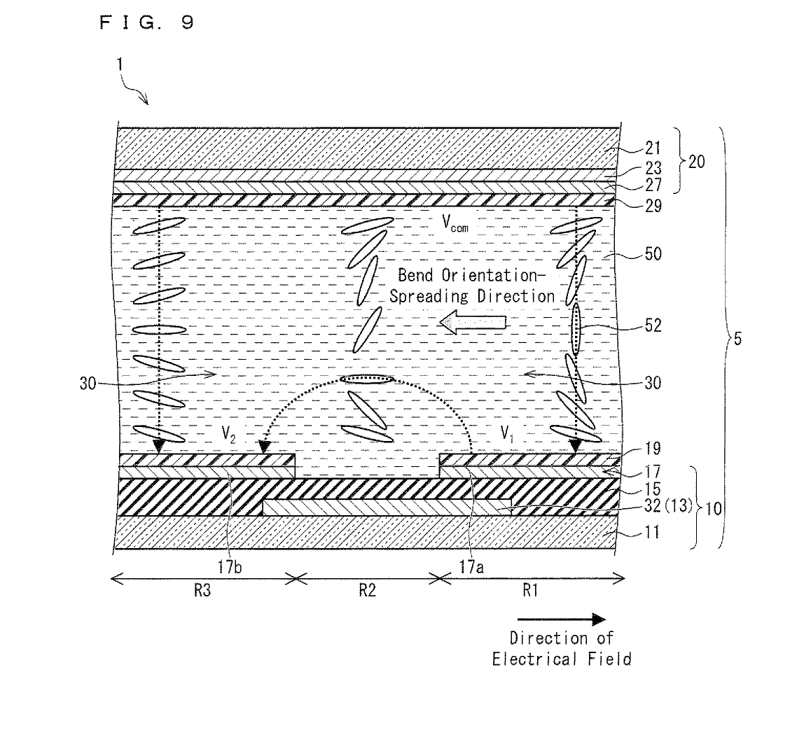

Next, the following description deals with a structure of the liquid crystal display panel 5 of the present embodiment. The liquid crystal display panel 5 of the present embodiment has the same structure as the liquid crystal panel 5 described earlier with reference to FIGS. 7 and 8.

That is, the liquid crystal display panel 5 includes (i) the first substrate 10 that is constituted by a first glass substrate 11 on which a wiring layer 13, an insulating layer 15, pixel electrodes 17, and a first alignment film 19 are provided; (ii) a second substrate 20 that is constituted by a second glass substrate 21 on which a color filter 23, a counter electrode 27, and a second alignment film 29 are provided; and (iii) a liquid crystal layer 50 that is sandwiched between the first substrate 10 and the second substrate 20. Further, a wave plate and a polarization plate are provided on a surface of each of the first substrate 10 and the second substrate 20, which surface is opposite to a surface facing the liquid crystal layer 50.

(Spray-Bend Transition)

The liquid crystal display panel 5 of the present embodiment is an OCB mode liquid crystal panel 5. As described earlier, in the OCB mode liquid crystal panel 5, the liquid crystal molecules 52 are in a spray orientation state while the liquid crystal display device 1 is in a power-off state (see FIG. 7). Therefore, it is necessary for the liquid crystal molecules 52 to have a transition (a spray-bend transition) from the spray orientation state into the bend orientation state when the liquid crystal display device 1 is powered on.

In view of the circumstances, according to the present embodiment, a transition voltage, which is different from a normal drive voltage, e.g., a high voltage of 25 V, is applied to the liquid crystal layer 50 so as to cause the spray-bend transition (see FIG. 2).

Then, in the liquid crystal display device 1 of the present embodiment, a period is secured during which all the gate bus lines 32 (GL1 to GLm) are simultaneously in an ON state while the transition voltage is being applied. During such a period, an identical data voltage (data signal) is written to ones of the plurality of pixels 30 that are connected to a corresponding one of the source bus lines 34 (SL1 through SLn).

That is, unlike a line sequential driving performed during the normal driving, the period is secured during which all the gate bus lines 32 are in the ON state while the transition voltage is being applied. This causes such an identical data voltage to be simultaneously written to the ones of the plurality of pixels 30 that are connected to the corresponding one of the source bus lines 34.

In a case where an inversion driving such as a line inversion driving is carried out with respect to the TFTs, the gate bus lines 32 are, in general, sequentially in the ON state. Then, electric potentials having respective different polarities are written to respective any adjacent ones of the plurality of pixels 30. That is, the different electric potentials are written to the respective adjacent pixel electrodes 17 between which a corresponding one of the gate bus lines 32 is provided. Accordingly, an electric potential difference occurs between the adjacent pixel electrodes 17, thereby causing a lateral electrical field to be generated.

In contrast, according to the present embodiment, all the gate bus lines 32 in the liquid crystal display panel 5 are simultaneously in the ON state so that a data voltage having an identical polarity is written (e.g., so that a white display is carried out with respect to the entire liquid crystal display panel 5). This causes an identical data voltage (data signal) to be written to ones of the plurality of pixels 30 that are connected to a corresponding one of the source bus lines 34 (SL1 through SLn). Since the identical electric potential is written to adjacent ones of the plurality of pixels 30 between provided, no electric potential difference occurs between the adjacent pixel electrodes 17 between which the corresponding one of the gate bus lines 32 is provided. Accordingly, no lateral electrical field is generated between the adjacent pixel electrodes 17.

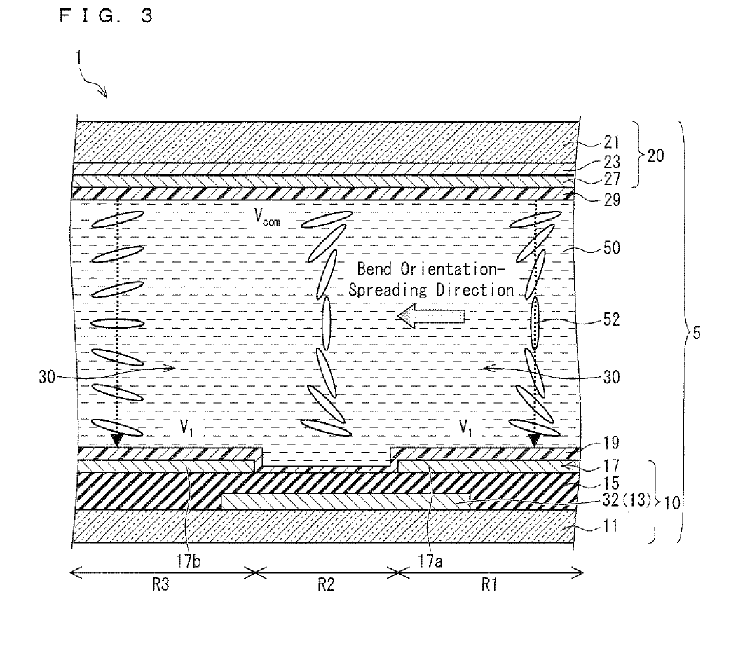

Specifically, as illustrated in FIG. 3, no electric potential difference occurs between adjacent two pixel electrodes 17a and 17b between which a corresponding one of the gate bus lines 32 is provided. As such, no lateral electrical field (electric flux line) is generated between the adjacent pixel electrodes 17a and 17b.

As a result, the liquid crystal molecules 52 do not stably orient in a horizontal direction in the region R2 above the corresponding one of the gate bus lines 32. Accordingly, a disturbance is reduced which occurs in a case where the bend orientation spreads from the region R1 above the pixel electrode 17a into the region R3 above the pixel electrode 17b, via the corresponding one of the gate bus lines 32.

As such, the bend orientation easily spreads into an adjacent one of the pixels 30, thereby making it possible to cause the spray-bend transition all over the display surface in a short period of time.

FIG. 3 is a cross-sectional view of the liquid crystal display device, schematically illustrating how the liquid crystal molecules orient while a voltage is being applied.

(Regarding Voltage Drop)

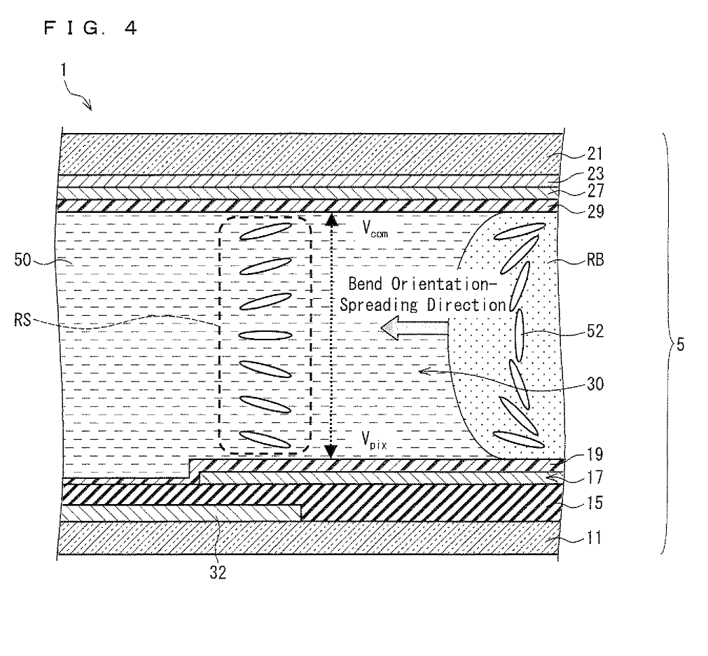

According to the liquid crystal display device 1 of the present embodiment, it is possible to prevent a drop in voltage to be applied to the liquid crystal molecules 52, which drop is likely to occur during the transition from the spray orientation into the bend orientation. This makes it possible to carry out the spray-bend transition in a short period of time. This is described with reference to FIG. 4. FIG. 4 is a cross-sectional view of the liquid crystal display 1, schematically illustrating how the bend orientation spreads.

(Line Sequential Driving)

The voltage drop occurring in a line sequential driving is described. The voltage drop occurs due to a change in electrical capacitance, which change occurs in response to a transition of the liquid crystal molecules 52 from the spray orientation state into the bend orientation state.

For example, in a case where the line sequential driving (scan driving) is carried out with use of the TFTs 36 as switching elements, the pixel electrodes 17 are electrically charged while the gates of the respective TFTs 36 are in an ON state. Generally, the electric charge thus charged is retained while the gates are in an OFF state.

While the gate is in the OFF state, if a transition of the liquid crystal molecules 52 in a corresponding one of the plurality of pixels 30 occurs from the spray orientation state into the bend orientation state and if a ratio of the bend orientation region to a whole region of the corresponding one of the plurality of pixels 30 varies, then the electrical capacitance in the liquid crystal layer 50 varies, accordingly.

(Electrical Capacitance)

Specifically, in the corresponding one of the plurality of pixels 30, if a region in which the liquid crystal molecules 52 are in the bend orientation state (the region RB in FIG. 4) spreads into a region in which the liquid crystal molecules 52 are in the spray orientation state (the region RS in FIG. 4) due to the spreading of the bend orientation (see thick arrow in FIG. 4), then an electrical capacitance C of the liquid crystal layer 50 increases. This is described below with use of mathematical formulas.

The electrical capacitance C of the liquid crystal layer 50 can be represented by the following mathematical formula (1):

C=∈·S/d (1)

In the mathematical formula (1), ∈ represents dielectric constant of the liquid crystal molecules 52, S represents an area of the pixel electrode 17, and d represents a thickness of the liquid crystal layer 50.

In a case where the liquid crystal molecules 52 have anisotropy in the dielectric constant ∈ and are p-type liquid crystal molecules, the dielectric constant ∈ is larger in the bend orientation state than in the spray orientation state.

As is clear from the mathematical formula (1), the electrical capacitance C of the liquid crystal layer 50 increases as the dielectric constant ∈ increases.

(Voltage)

Next, a relation is described between the electrical capacitance C and a voltage to be applied to the liquid crystal layer 50.

The relation between the electrical capacitance C and the voltage to be applied to the liquid crystal layer 50 can be represented by the following mathematical formula (2):

Q=C·V (2)

In the mathematical formula (2), Q represents an electric charge (an electric charge of the pixel electrode 17), and V represents a voltage (a voltage to be applied to the liquid crystal layer 50).

The pixel electrode 17 retains the electric charge while the gates are in the OFF state during the TFT driving. As such, the electric charge Q in the mathematical formula (2) becomes constant. It follows that the voltage V applied to the liquid crystal layer 50 varies according to a change in the electrical capacitance C.

As described earlier, the voltage V (a voltage of the pixels 30) applied to the liquid crystal layer 50 decreases, in a case where the electrical capacitance C of the liquid crystal layer 50 increases in response to the transition of the liquid crystal molecules 52 from the spray orientation state into the bend orientation state (see mathematical formula (1)). This causes a reduction in voltage to be applied to the liquid crystal molecules 52 (refer to mathematical formula (2)). Specifically, a transitional voltage (Vcom (electric potential of the counter electrode 23)−Vpix (electric potential of the pixel electrodes 17)) that was initially applied (see FIG. 4) is no longer retained.

As described above, while the pixel electrodes 17 is retaining the electric charge, the voltage to be applied to the liquid crystal layer 50 decreases as the bend orientation spreads. Accordingly, it was not possible to sufficiently apply the transition voltage. As a result, a delay occurred in the transition into the bend orientation.

(Keeping all Gate Bus Lines in on State)

In contrast, according to the liquid crystal display device 1 of the present embodiment, all the gate bus lines 32 are simultaneously put into in an ON state so as to eliminate a lateral electrical field between adjacent ones of the plurality of pixels 30, unlike the line sequential driving described earlier. This causes the bend orientation to easily spread, via the region R2 above a corresponding one of the gate bus lines 32.

In a case where, after all the gate bus lines 32 are simultaneously in the ON state, the ON state is kept for a predetermined period of time, then it is possible to prevent a delay in the transition into the bend orientation due to a drop in the transition voltage.

Specifically, the gates continue to receive an ON voltage for a given period of time, for example, a period of time from the ON state of all the gate bus lines to completion of the bend transition (see FIG. 2 which shows a waveform of the voltage to be applied during the transition to the bend orientation).

In the case where all the gate bus lines 32 are kept in the ON state (in a case where all the gate bus lines are always in the ON state), it is possible to prevent a drop in the voltage V (a voltage V applied to the liquid crystal layer 50), which drop is caused by the spreading of the bend orientation. As such, it is possible to prevent the delay in the transition to the bend orientation.

Specifically, as described earlier, according to the line sequential driving (which is the TFT driving), there are (i) a period during which the pixel electrodes 17 are electrically charged and (ii) a period during which the electric charge thus charged is retained. More specifically, the pixel electrodes 17 are charged every 16.67 milliseconds in a case where the writing is carried out at 60 Hz. That is, the writing is carried out at an interval of 16.67 milliseconds. If the bend orientation spreads within a pixel 30 during this interval, then a voltage drop occurs in the voltage to be applied to the liquid crystal molecules 52. Therefore, a speed at which the bend orientation spreads within the pixel 30 decreases.

In contrast, in a case where all the gate bus lines 32 are always in the ON state, then it is possible to achieve a state where the pixel electrodes 17 are always charged. Accordingly, even if the transition of the liquid crystal molecules 52 into the bend orientation state, a voltage drop rarely occurs in the voltage to be applied to the liquid crystal molecules 52. As such, it is possible to prevent the delay in the transition into the bend orientation.

A timing at which the gate bus lines 32 start to be put into the ON state is not particularly limited, provided that the timing falls within a range from (i) on or before the transition voltage is applied to the counter electrode to (ii) the time at which the application of the transition voltage is stopped (to the time at which the liquid crystal display device 1 returns to the displaying state).

Among others, the timing at which the gate bus lines 32 starts to be put into the ON state is preferably a timing that comes on or before the timing at which the transition voltage starts being applied, from the perspective that the delay in the transition to the bend orientation should be more surely prevented.

### Embodiment 2

Next, a second embodiment of the present invention is described. It should be noted that structures that are not described in the present embodiment are the same as those described in Embodiment 1. Further, members that have the same functions as those illustrated in figures referred to in Embodiment 1 are given the same reference numerals as those illustrated in the figures, and descriptions of the members are omitted, for convenience of description.

(Data Signal Line Serving as Source Bus Line)

In a liquid crystal display panel 5 in which pixels 30 are provided in a matrix manner, in a case where an identical data voltage (an identical data signal) is applied to all the source bus lines 34 when all the gate bus lines 32 are simultaneously put into the ON state, then the identical data voltage is to be written to all the pixels 30 of the liquid crystal display panel 5. Accordingly, it is possible to achieve a state where all the pixel electrodes 17 have an identical voltage all over the liquid crystal display panel 5.

In this case, an electric potential difference is reduced not only between any adjacent pixel electrodes 17 between which a corresponding one of the gate bus lines 32 is provided, but also between any adjacent pixel electrodes 17 between which a corresponding one of the source bus lines 34 is provided. Accordingly, the bend orientation easily spreads in all directions.

As a result, it is possible to achieve a liquid crystal display device that is capable of carrying out the spray-bend transition all over the display surface in a shorter period of time.

### Embodiment 3

Next, a third embodiment of the present invention is described. It should be noted that structures that are not described in the present embodiment are the same as those described in Embodiments 1 and 2. Further, members that have the same functions as those illustrated in figures referred to in Embodiments 1 and 2 are given the same reference numerals as those illustrated in the figures, and descriptions of the members are omitted, for convenience of description.

Unlike the liquid crystal display devices 1 described in Embodiments 1 and 2, a liquid crystal display device 1 of the present embodiment is characterized in that, in the line sequential driving, occurrence of a lateral electrical field is prevented by preventing an electric potential difference between any adjacent pixel electrodes 17 between which a corresponding one of gate bus lines 32 is provided.

(Waveform of Signal Applied to Storage Capacitor Electrode)

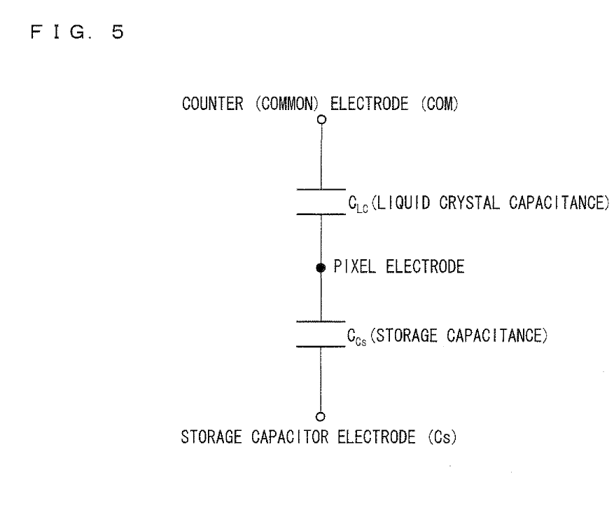

That is, according to a liquid crystal display device 1 employing an active matrix substrate (a main active matrix substrate) on which so-called storage capacitor electrodes are provided, a voltage to be applied to the liquid crystal layer 50 varies depending on an electric potential of the counter electrode (common electrode) and an electric potential of a corresponding storage capacitor electrode (see FIG. 5).

In view of the circumstances, the liquid crystal display device 1 of the present embodiment is arranged such that a voltage whose waveform has an amplitude of zero is applied to the storage capacitor electrodes, in a state where the gate bus lines 32 are sequentially put into their ON state and a transition voltage is applied to the common electrode (in a state where the bend transition is carried out while a line sequential scan is being carried out).

This makes it possible to reduce a lateral electrical field between any adjacent pixel electrodes between which a corresponding one of the gate bus lines, which any adjacent pixel electrodes are in the process of the transition into the bend orientation state in the line sequential driving. Therefore, it is possible to prevent a disturbance of the spreading of the bend orientation.

Note that, similarly to the timing at which the gate bus lines 32 are put into the ON state, a timing at which the amplitude of the voltage waveform to be applied to the storage capacitor electrodes starts to be zero is not particularly limited, provided that the timing falls within a range from (i) on or before the transition voltage is applied to the counter electrode to (ii) the time at which the application of the transition voltage is stopped (to the time at which the liquid crystal display device 1 returns to the displaying state). Further, the timing at which the amplitude of the voltage waveform to be applied to the storage capacitor electrodes starts to be zero is preferably a timing on or before the transition voltage is applied, from the perspective that the delay in the transition to the bend orientation should be more surely prevented.

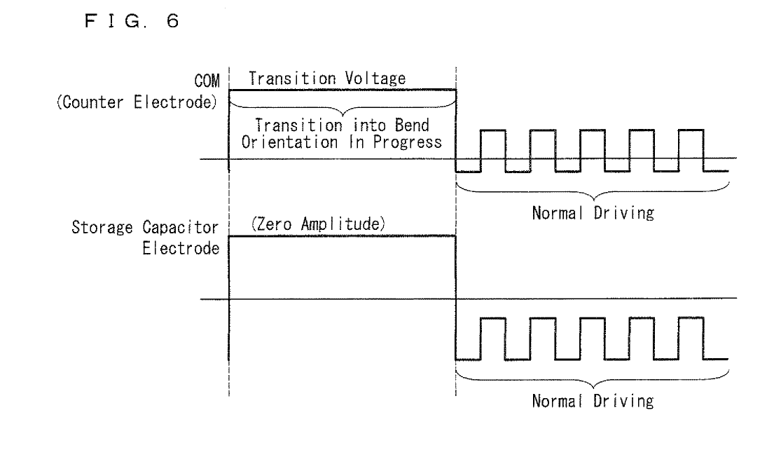

FIG. 5 is a circuit diagram showing an equivalent circuit of a pixel. FIG. 6 is a diagram showing a voltage to be applied to the storage capacitor electrodes.

### INDUSTRIAL APPLICABILITY

The present invention is applicable to a liquid crystal display device employing a large screen, because the present invention makes it possible to cause the spray-bend transition all over the display surface in a short period of time.

1. A method of driving an OCB mode liquid crystal display device,
said OCB mode liquid crystal display device including:
an active matrix substrate on which a plurality of pixel electrodes and a plurality of switching elements connected to the respective plurality of pixel electrodes are provided in a lattice manner;
a counter substrate on which a counter electrode is provided; and
a liquid crystal layer sandwiched between the active matrix substrate and the counter substrate,
the liquid crystal layer containing liquid crystal molecules that have positive dielectric anisotropy,
the liquid crystal molecules being in a spray orientation state while no voltage is applied to the liquid crystal layer, and a transition of the liquid crystal molecules occurring from the spray orientation state into a bend orientation state in response to a voltage applied to the liquid crystal layer,
the switching elements being transistor elements,
a plurality of gate bus lines and a plurality of source bus lines being provided on the active matrix substrate in a lattice manner,
each of the transistor elements being connected to at least one of the plurality of gate bus lines and to at least one of the plurality of source bus lines,
said method comprising the step of:
securing a period during which no electric potential difference occurs between any adjacent ones of the plurality of pixel electrodes between which a corresponding one of the plurality of gate bus lines is provided, at least while a transition voltage for causing a transition of the liquid crystal molecules into the bend orientation state is being applied to the liquid crystal layer, by simultaneously putting all of the plurality of gate bus lines into an ON state so that voltages of identical polarity are applied to the respective any adjacent ones of the plurality of pixel electrodes.

2. The method according to claim 1, wherein the all of the plurality of the gate bus lines, that were simultaneously put into the ON state, continue to be put into the ON state for a given period of time after the liquid crystal molecules start responding.

3. The method according to claim 2, wherein the given period of time is a period of time required for completion of the transition of the liquid crystal molecules from the spray orientation state into the bend orientation state.

4. The method according to claim 1, wherein a timing at which the all of the plurality of gate bus lines start to be put into the ON state comes on or before a period during which the transition voltage is being applied.

5. The method according to claim 1, wherein an identical signal voltage is applied to the transistor elements connected to the respective plurality of gate bus lines all of which are put into the ON state so that the any adjacent ones of the pixel electrodes between which the corresponding one of the plurality of gate bus lines is provided have an identical electric potential.

6. A method of driving an OCB mode liquid crystal display device,
said OCB mode liquid crystal display device including:
a main active matrix substrate on which a plurality of pixel electrodes and a plurality of switching elements that are connected to the respective plurality of pixel electrodes are provided in a lattice manner;
a counter substrate on which a counter electrode is provided; and
a liquid crystal layer sandwiched between the main active matrix substrate and the counter substrate,
the main active matrix substrate including storage capacitor electrodes,
the liquid crystal layer receiving a voltage which varies depending on an electric potential of the counter electrode and an electric potential of the storage capacitor electrodes,
the liquid crystal molecules contained in the liquid crystal layer being in a spray orientation state while no voltage is applied to the liquid crystal layer, and a transition of the liquid crystal molecules occurring from the spray orientation state into a bend orientation state in response to a voltage applied to the liquid crystal layer,
said method comprising the step of:
securing a period during which an amplitude of a voltage waveform to be applied to the storage capacitor electrodes is zero at least while a transition voltage for causing a transition of the liquid crystal molecules into the bend orientation state is being applied to the liquid crystal layer.

7. The method according to claim 6, wherein a timing at which the voltage waveform whose amplitude is zero starts being applied to the storage capacitor electrodes is a timing that comes on or before a period during which the transition voltage is being applied.

8. A liquid crystal display device that is driven by a method as set forth in claim 1.
